(19) United States
(12) Patent Application Publication
(10) Pub. No.: US 2014/0232518 A1
(43) Pub. Date: Aug. 21, 2014

(54) SYSTEMS AND METHODS FOR AN AUTOMATED PARKING FACILITY

(71) Applicant: CAH TECHNOLOGY, LOS ANGELES, CA (US)

(72) Inventor: Matthew Stoehr, Los Angeles, CA (US)

(73) Assignee: CAH TECHNOLOGY, LOS ANGELES, CA (US)

(21) Appl. No.: 14/179,419

(22) Filed: Feb. 12, 2014

Related U.S. Application Data
(60) Provisional application No. 61/765,528, filed on Feb. 15, 2013.
(60) Provisional application No. 61/890,051, filed on Oct. 11, 2013.

(51) Int. Cl. G07C 9/00

(52) U.S. Cl. CPC G07C 9/00007
USPC 340/5.6

(57) ABSTRACT

Systems and methods for automated parking facilities are described herein. Users may purchase self-parking and/or valet parking with an access key. The access key may comprise various formats, such as, a barcode, a machine-readable representation of data, PIN code, or the like. The access key may be distributed via a print medium or a mobile computing device. The automated parking facility system may be interface with multiple parking facilities and/or may provide accounts across multiple parking facilities. The automated parking facility system may be configured to wirelessly open entrance and/or exit gates of parking facilities.

### INCORPORATION BY REFERENCE OF ANY PRIORITY APPLICATIONS

This application claims benefit of U.S. Provisional Patent Application Ser. No. 61/765,528 filed Feb. 15, 2013, which is hereby incorporated by reference in its entirety.

Additionally, this application claims benefit of U.S. Provisional Patent Application Ser. No. 61/890,051 filed Oct. 11, 2013, which is hereby incorporated by reference in its entirety.

### BACKGROUND

1. Field

Several embodiments of the disclosure relates generally to the field of parking structure control systems, and more specifically to methods, systems, and devices that automate entry, exit, payment, and account management for users and/or operators of parking facilities.

2. Description of the Related Art

There are presently a variety of systems and methods for managing payments to parking garages and controlling the entry and exit of vehicles. Parking facility control systems may include entry and exit gates that open when the user swipes a credit card or presses a button to request or receive a paper ticket. These systems process transactions based on the paper ticket or require attendants or cashiers to manually process transactions.

### SUMMARY

The systems, methods, and devices described herein each have several aspects, no single one of which is solely responsible for its desirable attributes, which provide for an automated parking facility.

In several embodiments, there is provided an automated parking facility system comprising a non-transitory data storage device configured to store data relating to one or more accounts for one or more users of a parking facility, the data comprising an access key associated with the one or more accounts; an account manager engine configured to generate the one or more accounts and store the one or more accounts in the non-transitory data storage device, a communication engine configured to transmit account data comprising the access key to one or more user computing devices, an interface engine configured to transmit account data comprising the access key to the automated gate system of the parking facility and to receive account activity data from the parking facility, and one or more computing systems configured to operate the account manager engine, the communication engine, and the interface engine, wherein the one or more computing systems comprises one or more hardware processors and a non-transitory data storage medium. In several embodiments, an automated gate system of the parking facility is configured to receive the access key associated with the one or more accounts as data input to open one or more access points (e.g., entry or exits) of the automated gate system of the parking facility.

In several embodiments, there is provided an automated parking facility system comprising an account manager engine configure to generate one or more global accounts. An access key is associated with the one or more global accounts and the automated parking facility system communicates with an automated gate system of a parking facility that is configured to receive the access key as input to open one or more access points. The automated parking facility system also comprises a communication engine configured to transmit account data comprising the access key to one or more user computing devices. The automated parking facility system optionally comprises an interface engine configured to transmit account data comprising the access key to the automated gate system of the parking facility. The interface engine is optionally further configured to create one or more local user accounts at the parking facility associated with the one or more global accounts.

In several embodiments, there is provided an automated parking facility system comprising an account manager engine configure to generate one or more accounts, an access key being associated with the one or more accounts, a communication engine configured to transmit account data comprising the access key to one or more user computing devices, an interface engine configured to transmit account data comprising the access key to an automated gate system of the parking facility. The automated gate system of a parking facility is configured to open one or more access points of the automated gate system of the parking facility based at least in part on location data determined from the access key and wireless data input from one or more user computing devices.

In several embodiments, there is provided an automated parking facility system comprising an account manager engine configure to generate one or more accounts, an access key being associated with the one or more accounts, a communication engine configured to transmit account data comprising the access key to one or more user computing devices, an interface engine configured to transmit account data comprising the access key to an automated gate system of a parking facility, the automated gate system of the parking facility being configured to receive the access key associated with the one or more accounts as data input to open one or more access points.

In several embodiments, an automated parking facility system comprises an account manager engine configure to generate one or more accounts for one or more users of at least a first parking facility. Balance data is associated with the one or more accounts, in several embodiments. The automated parking facility system further comprises an interface engine configured to transmit account data associated with the one or more accounts to the first parking facility.

In several embodiments, a non-transitory computer storage comprises instructions for causing an automated parking facility system to implement an account manager engine, a communication engine, and an interface engine. The account manager engine, in several embodiments, is configured to generate one or more accounts. An automated gate system of a parking facility is configured to receive the access key as input to open one or more access points (e.g., entries or exits) of the parking facility. In several embodiments, the communication engine is configured to transmit account data comprising the access key to one or more user computing devices. In several embodiments, the interface engine is configured to transmit account data comprising the access key to the automated gate system of the parking facility.

In some embodiments, the automated parking facility comprises a non-transitory data storage device configured to store data relating to one or more accounts. In some embodiments, the data comprises an access key associated with the one or more accounts.

In some embodiments the interface engine is further configured to receive account activity data from the parking facility.

In some embodiments, one or more computing systems are configured to operate the account manager engine, the communication engine, and the interface engine. In several embodiments, the one or more computing systems comprise one or more hardware processors and a non-transitory data storage medium. In several embodiments, the one or more computing systems are local to the parking facility, while in additional embodiments they are remote (e.g., accessed through a network). Combinations of local and remote computing systems are also used, in several embodiments.

In some embodiments comprising a non-transitory data storage device, the non-transitory data storage device is further configured to store data relating to one or more accounts for one or more users of at a second parking facility. The account manager engine is configured, in several embodiments, to debit and credit the balance data associated with the one or more accounts. The interface engine is configured, in several embodiments, to transmit account data associated with the one or more accounts to the second parking facility.

In some embodiments, the automated gate system of the parking facility is further configured to check if the access key is associated with the one or more local user accounts of the parking facility. This allows, for example, identification of a user of the system, and tailoring of the system response to that user (e.g., based on past experience with the user).

In some embodiments, the automated gate system of the parking facility can be configured to issue a paper ticket. This can occur, for example, if the access key is rejected at an entry gate of the parking facility, if the system is subject to a slow-down or other disruption in communication with other components of the system.

In some embodiments, the automated gate system of the parking facility is configured to check if there is an entry timestamp associated with the access key (e.g., to begin a “clock” that monitors the duration a user with that access key is making use of the parking facility).

In some embodiments, the interface engine is configured to update the one or more local user accounts at the parking facility associated with the one or more global accounts.

In some embodiments, the access key comprises a barcode readable by the automated gate system of the parking facility from the one or more user devices (e.g., mobile phones, smart phones, tablets, etc).

In some embodiments, the data relating to the one or more global accounts comprises balance data. In several embodiments, the global accounts are able to be configured to allow automatic balance updates, at such time that the balance data is below a configurable balance level. Thus, in several embodiments, the one or more accounts can be configured to be “topped-up” to a threshold balance.

In some embodiments, the automated gate system of the parking facility is configured to open access points of the first parking facility based at least in part on the balance data associated with one or more global accounts. For example, an exit point may be opened in response to the presentation of an access code associated with an account having a balance greater than the charge owed based on the duration of parking (and/or other services) incurred. If the balance in the account is insufficient, the account may be automatically “topped-up” and/or the user may be prompted to add additional funds to the account.

In some embodiments, the automated gate system of the parking facility is configured to receive alternative payment based at least in part on the balance data associated with one or more global accounts. In several embodiments, the automated parking facility system is configured to communicate/transact with third-party payment systems (e.g., PayPal™, Square^{SM}, etc.).

In some embodiments, the access key is usable for parking validation at an establishment (e.g., a vendor) associated with the parking facility.

In some embodiments, a balance associated with one or more global accounts is updated from an external funding source (e.g., PayPal™, Square, etc.).

In some embodiments, the access key is displayable from a mobile application of the one or more user computing devices.

In some embodiments, the access key is usable for additional services and activities (e.g., services and/or purchases separate from parking).

In some embodiments, the automated gate system of the parking facility is configured to receive the access key as data input wirelessly.

In some embodiments, the account manager engine is configured to receive a request to generate one or more global accounts for one or more users of the parking facility. The request to generate the one or more global accounts optionally comprises web data.

In some embodiments, a mobile application, associated with the automated parking facility system, is configured for the one or more user computing devices.

In some embodiments, the access key comprises a printed medium from the one or more user computing devices. In such embodiments, the printed medium is readable by the automated gate system of the parking facility.

In some embodiments, the automated gate system of the parking facility is configured to receive wireless data input through Wi-Fi, GPS, radio frequency, Bluetooth, some other location data, or some combination thereof.

In some embodiments, the automated gate system of the parking facility is further configured to receive wireless data input through radio frequencies.

In some embodiments, the one or more user computing devices comprise a smartphone, mobile phone, tablet, or laptop computer. Other mobile devices are also used, in several embodiments.

In some embodiments, the automated gate system of the parking facility is configured to detect an access key and push a notification to the one or more user computing devices (e.g., a welcome message, a promotional message, a low balance message, etc.).

In some embodiments, an automated gate system of a first parking facility is configured to open access points of the first parking facility based at least in part on the balance data associated with one or more accounts.

In some embodiments, the data relating to one or more accounts for one or more users of at least the first parking facility further comprises an access key. An automated gate system of the first parking facility is configured to receive the access key associated with the one or more accounts as data input to open one or more access points of the automated gate system of the first parking facility.

In some embodiments, the interface engine is configured to add, modify, and delete local accounts of the parking facility.

In several embodiments, there is provided non-transitory computer storage comprising instructions for causing an automated parking facility system to implement an account manager engine configured to generate one or more accounts for one or more users of a parking facility and store the one or more accounts in non-transitory computer storage, wherein an automated gate system of the parking facility is configured to receive the access key associated with the one or more accounts as a data input to open one or more access points of the automated gate system of the parking facility, a communication engine configured to transmit account data comprising the access key to one or more user computing devices; and an interface engine configured to transmit account data comprising the access key to the automated gate system of the parking facility and to receive account activity data from the parking facility.

### BRIEF DESCRIPTION OF THE DRAWINGS

FIG. 1 depicts a general schematic overview of one embodiment of the systems disclosed herein.

FIG. 2 depicts a flowchart of one embodiment of a parking structure computing system used to perform automated parking transactions as described herein.

FIG. 3 depicts a flowchart of one embodiment of a smartphone app used to authenticate users and conduct parking transactions as described herein.

FIG. 4 depicts a flowchart of one embodiment of a computing system used to manage user accounts and account balances as described herein.

FIG. 5 depicts a general schematic overview of one embodiment of a parking structure computing system used to detect approaching vehicles as described herein.

FIG. 6 depicts a general schematic overview of one embodiment of a parking structure computing system used to detect customers preparing to exit the structure as described herein.

FIG. 7 depicts a flowchart of one embodiment of a parking structure computing system used to manage user authentication and parking transactions as described herein.

### DETAILED DESCRIPTION

### General

In view of the foregoing, it is an object of several embodiments of the present invention to provide systems and methods for automating detection of arriving and departing users of a parking facility. In some embodiments, the systems and methods include automatically identifying a user based on an associated access key, and determining whether the user has an active account in the automated parking facility system.

It is also an object of several embodiments of the systems disclosed herein to provide systems and methods for managing user accounts for parking facilities. In some embodiments, the systems and methods include managing account creation, accepting payments, processing parking transactions, crediting and debiting the account balance, and/or allowing automated account recharging.

It is also an object of several embodiments of the systems disclosed herein to reduce the time required for a user to conduct a parking transaction. In some embodiments, the systems and methods include detecting approaching vehicles and drivers, receiving a transmitted access key without user interaction, pre-screening the access key to verify the associated account, detecting that the vehicle is approaching an entry or exit gate, and/or automatically opening the gate.

Disclosed herein, in several embodiments, are systems that provide users (who, in some embodiments, are enrolled as members) the opportunity to purchase self-parking and/or valet parking at select locations by using a personalized code known, in several embodiments, as an access key, comprising a variety of formats. For example, an access key may comprise a barcode, a machine readable representation of data, PIN code, one or more license and/or vehicle identifiers, or the like. In some embodiments, the personalized code is distributed to the user via a print medium (for example, a receipt or credit card). In some embodiments, electronic transmission (for example, email, wireless, Bluetooth, etc.) is used to electronically transmit the access key from a user mobile device to an automated gate system at a parking facility. In some embodiments, the personalized code is transmitted to a mobile communications device of the user (for example, a cell phone, smart phone, computer tablet, transponder, or the like).

In some embodiments, after enrollment with the system to establish an account, the user is able to add funds to their parking account in advance (or, in some embodiments, on an instantaneous as-needed basis at a parking facility) in specified stored value amounts (for example $25, $50, $75 and $100, or any value between or greater than those values listed). When entering a parking facility that employs the systems disclosed herein, the user presents the personalized code to the system. Manners of presenting the personalized code are disclosed in more detail below. The user is then identified as being “in” a parking facility; the system records the fact of such user's entrance into the parking facility and, in several embodiments, begins a timer to record the duration of time that the user is “in” the parking facility. In several embodiments, the system runs a timer in predetermined increments, for example, each 30 minutes or any portion thereof. In several embodiments, the time is rounded to the nearest particular whole number of minutes (for example, 15 minutes, 30 minutes, 60 minutes, etc.). In several embodiments, the duration of time that results in a parking charge (and the amount charged) varies depending on the day (for example, weekday versus weekend) and/or the time of day. At such time that the user exits the parking facility, the user once again presents to the system the personalized code. In several embodiments, the second presentation of the code stops the timer associated with that user's parking duration and the system calculates a parking charge. That parking charge is then debited from that user's account.

In several embodiments, the user has the ability to have the user's account automatically ‘reload’ or ‘top up’ when the account balance reaches a predetermined level set by the user in advance (for example, when the account balance drops below, for example $10, an additional sum of money will be added into the account, to bring the account balance to a user-defined balance, for example $50). In several embodiments, the system displays to users (upon entry and/or exit of a parking facility) the remaining balance on their account. In several embodiments wherein a user employs a mobile communications device, the balance may optionally be displayed via a mobile device application.

In several embodiments, users may optionally enroll in a program to be identified as a Member, such enrollment being associated with, in several embodiments an additional fee. As an incentive for users to enroll as Members, in several embodiments, Members are rewarded with, for example, complimentary self-parking, reduced rates, premium reserved parking locations, and the like.

### System Technology

In several embodiments, the systems comprise websites which enable users of the system to initially enroll with the system. In addition, in several embodiments, the website enables a user to manage their account (for example, add funds, set-up and/or adjust automatic account reloading, change password, review account history, close account, set up a temporary personalized code for a guest user, etc.). In several embodiments, the systems (including the website and/or the various levels of account which a user may enroll in) are customized to apply to individual parking facilities or properties (for example a single shopping center or office building) or to a group of parking facilities or properties under common ownership or management.

In several embodiments, the user's personalized code is available in a variety of printed and/or electronic means. In several embodiments, the codes are distributed to a user by one or more delivery formats such as paper (including but not limited to a driver's license like or credit card-like object), email, downloadable through mobile web applications and wirelessly for hands free operations.

In some embodiments in which a user employs a mobile device, the personalized code will be available for presentation to the parking system via a mobile-device application operating on the mobile device. Further, in several embodiments, the mobile-device application will also allow the user to login to their account and perform the functions disclosed above from their mobile device.

In some embodiments, the access key may comprise and/or be associated with license plate numbers and/or vehicle identifiers. In a non-limiting example, the automated parking facility system may comprise license plate recognition equipment. A vehicle may enter and/or exit an automated parking facility when the parking facility automatically scans and/or reads the license plate of a vehicle with the license plate recognition equipment. As a result, a user may park at and/or use an automated parking facility without stopping and/or needing to present anything at the gates of the parking facility. In some embodiments, a keycard, a wireless device, and/or radio frequency card may be distributed to users or vehicles that transmits the account that is associated with the keycard, wireless device, and/or radio frequency card. The license plate and/or vehicle identification technologies disclosed herein may be used in combination with other methods, techniques, and/or systems of the present disclosure.

In several embodiments, parking facilities employing the systems disclosed herein comprise parking control equipment (for example, entry/exit gates) to accept payment through the systems. The parking control equipment and/or parking facility system is equipped, in several embodiments, to add, modify or delete user accounts. In several embodiments, once a user enrolls with the parking program, the user's personalized code and account balance are transmitted to the parking control equipment via an application programming interface. In several embodiments, this interface removes, reduces, or otherwise limits human interaction with the parking control equipment (for example, there is no need for cash transactions and/or parking attendants, though these features may optionally be maintained, depending on other factors related to the parking facility) and allow the account to be active immediately upon enrollment. This integration also provides, in several embodiments, historical parking usage and remaining account balance information to be provided to the user on one or more of the associated website and the applicable mobile-device application.

In some embodiments, parking facility equipment and/or gate opening systems may be supplied by a third-party, which is referred to herein as a “third-party parking facility system.” The automated parking facility system may be configured to work with a third-party parking facility system and/or third-party parking equipment, which is illustrated in further detail below. For example, SKIDATA®, a third-party equipment provider, provides parking facility equipment and/or gate opening systems that may be integrated with some embodiments of the automated parking facility system. Another example of a third-party equipment provider may be Standard Parking Systems, though, advantageously, the systems disclosed herein are able to “bridge” to parking equipment from any manufacturer

In some embodiments, the automated parking facility system is integrated with third-party parking facility systems to reduce data processing latency, equipment latency, and/or handle disaster recovery and/or failover. For example, user accounts may be created in the third-party parking facility system in addition to the accounts in the automated parking facility system. In some embodiments, global and/or universal user accounts may be associated with the local user accounts at third-party parking facility systems. The entry/exit gates may be under local control of the third-party parking facility based on local user accounts, which may reduce latency for opening and/or closing the gates. In some embodiments, if entry/exit gates were directly controlled by the automated parking facility system, a user may have to wait at a gate because of data and/or processing latency from the automated parking facility system to the local parking equipment because of processing, internet, and/or other communication latency. Additionally, there may reduced data processing latency for updating balances for accounts because all updates may occur locally at the third-party parking facility systems before being transmitted to the automated parking facility system. In some embodiments, the creation of local user accounts allows for disaster recovery and/or failover. For example, if there is a system failure and/or communication network failure related to the automated parking facility system the local parking system may continue functioning because the local user accounts have been loaded into the local system and may operate independently of the automated parking facility system.

In some embodiments, there may be variations of disaster recovery and/or failover. For example, while there is an automated parking facility system failure and/or communication failure, transaction data that would normally be communicated to the automated parking facility system during or immediately following the completion of a transaction may be stored and/or queued until the automated parking facility system is available. A data structure and/or system such as a queue, priority queue, first in first out, stack, or the like may be used to store the failover transaction data for local users. As communication to the automated parking facility system returns a recovery procedure and/or module may be activated to process and/or send transaction data from the queue to the automated parking facility system. Therefore, in some embodiments, account data across one or more parking facilities may become synchronized and/or consistent at the automated parking facility system following a disaster and/or system failure. In some embodiments, the queue system disclosed herein for synchronizing accounts may be implemented in the absence of a disaster recovery and/or failover situation.

In several embodiments, users enter and exit a parking facility utilizing their personalized code and their account is appropriately debited for the time spent in the parking facility. In addition, depending on the parking location, auxiliary services are available (for example, automobile wash and/or maintenance/service procedures), which can be optionally debited from a user's account.

In several embodiments, as disclosed above, users may either opt for self-parking, or may choose to use valet parking services, the charges for which can be deducted from the user's account via the personalized code.

Advantageously, in several embodiments, users that are parking in a system-equipped parking facility may process business-related parking validations through their personalized code. In several such embodiments, a single user may have multiple personalized codes and accounts (for example, one for personalized use and one for business use). Likewise, for businesses, a single account may be associated with a plurality of personalized codes (for example, Company A has five personalized codes, one for each of its five employees).

In some embodiments, business-related parking validations may be initiated and/or provided at business near, related, and/or associated with parking facilities. Businesses such as movie theaters, restaurants, and/or any other establishment associated with the parking facility may interact and/or participate in the automated parking facility system. For example, movie theater customers may receive free parking validations and/or two hour free parking validations through movie theater attendance. After a movie theater customer has presented their ticket and/or paid for a movie, the movie theater may comprise a scanner and/or kiosk that communicates with the automated parking facility system. A customer may then present their mobile device with an access key and/or other medium with an access key to receive their validation and/or credit. The scanner and/or kiosk may communicate with the automated parking facility system by updating the account information and/or data associated with the presented access key.

In several embodiments, third-party payment systems are used to process and/or manage payment mechanisms and interactions for the user. For example, PayPal™ may be used as a third party-payment system and/or as an external funding source by a user as well as other providers, including but not limited to Serve^{SM}, Square, Mobilized, ING Direct, amazon Payments™, and the like.

In several embodiments, upon enrollment, a user has the option of choosing to participate in an automatic account reload program. In those embodiments wherein the user opts-in, the user may choose from pre-determined balance thresholds at which the account will be reloaded (for example, a minimum active balance) and also may define the amount added to the parking account (for example, a specific dollar amount or an amount sufficient to have the balance reach a certain predetermined value) from another source of user money (for example, the user's checking account).

### Computing Systems

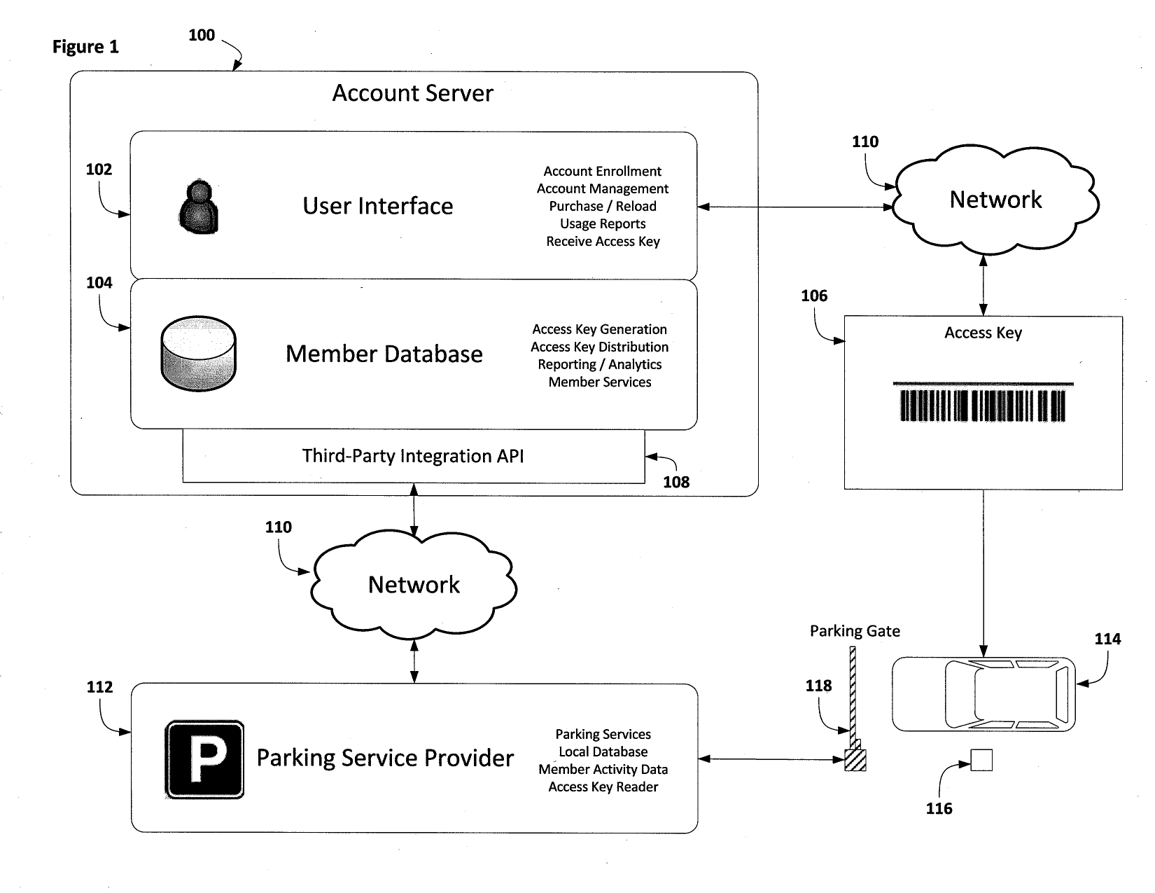

In several embodiments, the automated parking facility systems comprise, at least in part, an account server 100 as illustrated in FIG. 1. FIG. 1 depicts a general schematic overview of one embodiment of an account server that is in communication with one or more parking service providers 112 and one or more parking service users (represented in FIG. 1 as a driver of a vehicle 114) via one or more networks 110. In several embodiments, the account server 100 comprises a central processing unit, a random access memory, a read-only memory, a mass storage device, and one or more input/output (I/O) interfaces for communicating to users and networks. In several embodiments, the account server 100 also comprises computing devices suitable for controlling, communicating with, processing transactions in, and/or generating reports from a member database 104. The account server 100 may be used to implement one or more of the systems, transactions and/or methods described herein. In addition, in some embodiments, the account server 100 may be configured to apply one or more of the parking facility related calculations and transactions described herein. While FIG. 1 illustrates a non-limiting embodiment of an account server 100, it is recognized that the functionality provided for in the components and modules of account server 100 may be combined into fewer components and modules or further separated into additional components and modules. For example, components and modules of account server 100 may be implemented on a user device such as an iPhone® or iPad®.

In some embodiments, the automated parking facility systems comprise, at least in part, computing systems associated with a parking service provider 112. In some embodiments, the account server 100 implements a third-party integration Application Programming Interface (API) 108 to facilitate communication with the parking service provider 112 via one or more networks 110. The computing systems associated with the parking service provider 112 typically comprise a central processing unit, a random access memory, a read-only memory, a mass storage device, and one or more I/O interfaces for communicating to users and networks. In several embodiments, these systems also comprise computing devices suitable for controlling, communicating with, processing transactions in, and/or generating reports from a user database and/or a transaction database. In several embodiments, these systems also comprise computing devices suitable for controlling and/or communicating with one or more access key readers 116 and/or parking gates 118 to manage access to a parking facility.

In some embodiments, there may be some variations of the API 108. For example, the API 108 may comprise code modules for interfaces in one or more programming languages. An interface may comprise signatures of code modules for sending and/or receiving account data, member activity data, or the like. In a non-limiting example, there may be a code interface module for updating user activity with inputs comprising an access key identifier and account activity data such as, amount spent, the parking facility used, time in, time out, or the like. The code interface module for updating user activity may not have any specific code instructions but may rather comprise the name of the code module and its input variables. When implementing and/or adapting the automated parking facility system for a third-party parking facility the code interface modules may be implemented with code instructions and/or hardware for the specific third-party parking facility. For example, a parking facility may comprise SKIDATA parking systems. The automated parking facility system may be adapted to a SKIDATA parking facility by implementing the interface code modules to communicate with the SKIDATA parking system. For example, a SKIDATA interface implementation may use SKIDATA code libraries such as a communication layer corn interface, an electronic payment interface, a transaction notification interface, or the like. The API 108 may allow for efficiently, flexibly, and/or scalably implementing automated parking facility systems with third-party parking facilities with their own propriety computer systems. For example, the code modules of the automated parking facility systems may be the same except for the implemented code interface modules that communicate with a third-party parking facility. In some embodiments, there may be other variations of the API 108 which may include hardware and/or software combinations to communicate with a third-party parking facility and/or system.

Unlike traditional point of sale systems, the API 108 may allow for integration of third-party parking facility systems and/or third-party parking facility equipment with the automated parking facility system. For example, a conventional storefront may have the capability of supporting an account or rewards cards across multiple stores with configured registers or scanners of the storefront. However, the point of sale system associated with the storefront is configured for the registers and/or systems specific to that storefront. Therefore, unlike the point of sale system of a conventional storefront, which cannot be extended to stores with different registers, scanners, and/or back end systems, the automated parking facility system may be adapted, configured, and/or integrated with various third-party parking facility equipment systems and/or different gate opening equipment because the API 108 allows for communications and/or integration with such third-party systems and/or equipment. In some embodiments, the API 108 may be configured for different levels of accounts. For example, there may be special privileges available for different types of accounts. Certain gates, such as a gate for valet parking, may only open for users with valet parking access. In some embodiments, based on the type of account, a user may pay a different parking rate and/or scale so they are paying a different rate than a normal and/or regular guest. The API 108 may be configured to communicate with the local parking facility system to charge different rates and/or provide different levels of access.

### Account Server Modules

In an embodiment, the account server 100 implements an automated parking transaction module (not shown in FIG. 1) that carries out the functions described herein with reference to automated parking transactions, including any one or more of the transactions and functions described above and below. In an embodiment, the account server 100 implements a user interface module 102 that carries out the functions described herein with reference to user input, including any one or more of the transactions and functions described above and below. In an embodiment, the account server 100 implements a member database module that carries out the functions described herein with reference to data storage, including any one or more of the transactions and functions described above and below. These modules may be executed on the account server 100 by a central processing unit discussed further below.

The word “module,” as used herein, refers to logic embodied in hardware or firmware, or to a collection of software instructions, possibly having entry and exit points, written in a programming language, such as, for example, COBOL, CICS, Java, Lua, C or C++ or Objective C. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may also be implemented by hardware or firmware. Generally, the modules described herein refer to logical modules that may be combined with other modules or divided into sub-modules despite their physical organization or storage.

### Computing System Device/Operating System

The account server 100 may run on a variety of computing devices, such as, for example, a mobile device or a server, a Windows server, a Structure Query Language server, a Unix server, a personal computer, a mainframe computer, a laptop computer, a cell phone, a personal digital assistant, a kiosk, an audio player, a smartphone, a tablet computing device, and so forth. The account server 100 is generally controlled and coordinated by operating system software, such as iOS, z/OS, Windows 95, Windows 98, Windows NT, Windows 2000, Windows XP, Windows Vista, Windows 7, Windows 8, Linux, BSD, SunOS, Solaris, or other compatible operating systems. In Macintosh systems, the operating system may be any available operating system, such as MacOS X. In other embodiments, the account server 100 may be controlled by a proprietary operating system. Conventional operating systems control and schedule computer processes for execution, perform memory management, provide file system, networking, and I/O services, and provide a user interface, such as a graphical user interface (“GUI”), among other things.

### Network

In the embodiment of FIG. 1, the account server 100 is coupled to a network 110, such as a LAN, WAN, or the Internet, for example, via a wired, wireless, or combination of wired and wireless, communication link. The network 110 communicates with various computing devices and/or other electronic devices via wired or wireless communication links. In the non-limiting embodiment shown in FIG. 1, the network 110 is communicating with the account server 100 and/or one or more parking service providers 112, and communicates access key 106 and other information to users of the service.

Access to the automated parking transaction module of the account server 100 by parking service providers 112 and/or by users is, in several embodiments, through a web-enabled user access point such as a personal computer, cellular phone, laptop, or other device capable of connecting to the network 110. In several embodiments, such devices employ, for example, a browser module that uses text, graphics, audio, video, and other media to present data and to allow interaction with data via the network 110.

In several embodiments, the browser module is implemented as a combination of an all points addressable display such as a cathode-ray tube (CRT), a liquid crystal display (LCD), a plasma display, touch screen display or other types and/or combinations of displays. In addition, the browser module is optionally implemented to communicate with input devices and also comprises software with the appropriate interfaces which allow a user to access data through the use of stylized screen elements such as, for example, menus, windows, dialog boxes, toolbars, and controls (for example, radio buttons, check boxes, sliding scales, and so forth). Furthermore, in several embodiments, the browser module communicates with a set of input and output devices to receive signals from the user.

In several embodiments, the input device(s) comprise one or more of a keyboard, roller ball, pen and stylus, mouse, trackball, voice recognition system, or pre-designated switches or buttons, or combinations thereof. In several embodiments, the output device(s) comprise a speaker, a display screen, a printer, or a voice synthesizer. In addition a touch screen may act as a hybrid input/output device. In an additional embodiment, a user interacts with the system more directly such as through a system terminal connected to the account server 100 without communications over the Internet, a WAN, or LAN, or similar network.

In some embodiments, the account server 100 comprises a physical or logical connection established between a remote microprocessor and a mainframe host computer for the express purpose of uploading, downloading, or viewing interactive data and databases on-line in real time. In several embodiments, the remote microprocessor is operated by an entity operating the account server 100, including the client server systems or the main server system, and/or may be operated by one or more of the data sources and/or one or more of the computing systems. In some embodiments, terminal emulation software is used on the microprocessor for participating in the micro-mainframe link.

### User Access Point

In an embodiment, the user accesses the account server 100 via an iPhone®, an iPad®, an Android™ computing system, a smartphone, a tablet computing device, a mobile device, a personal computer, a laptop computer, a cellular phone, a GPS system, a Blackberry® device, a portable computing device, a server, a computer workstation, a local area network of individual computers, an interactive kiosk, a personal digital assistant, an interactive wireless communications device, a handheld computer, an embedded computing device, or the like.

### Other Systems

In addition to the systems that are illustrated in FIG. 1, the network 110 may also communicate with other data sources or other computing devices, depending on the embodiment. In several embodiments, the account server 100 also comprises one or more internal and/or external data sources. In some embodiments, one or more of the data repositories and the data sources are implemented using a relational database, such as DB2, Sybase, Oracle, CodeBase and Microsoft® SQL Server as well as other types of databases such as, for example, a signal database, object-oriented database, and/or a record-based database.

### Method for Processing Parking Transactions

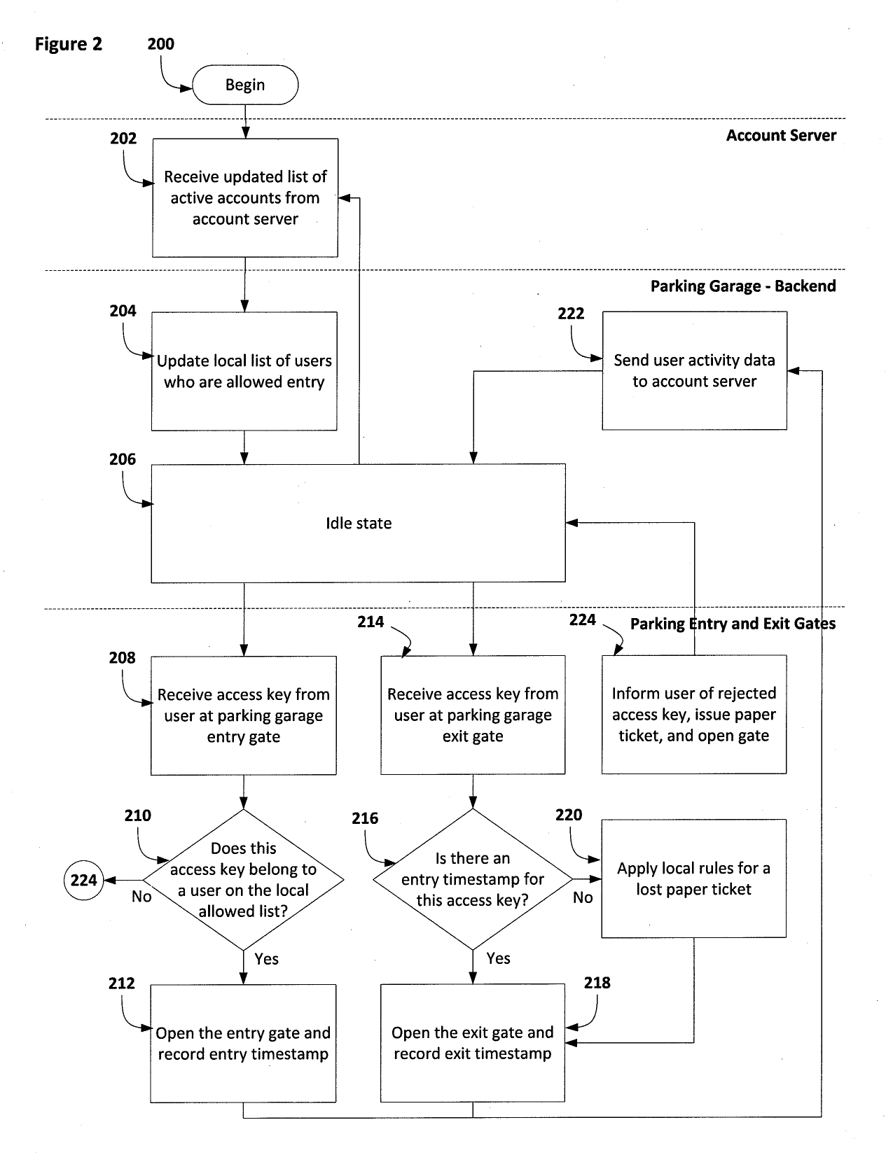

FIG. 2 illustrates one non-limiting embodiment by which the parking service provider 112 exchanges information with the account server 100 regarding parking transactions generated by users of the parking service. At block 202, the parking service provider 112 receives an updated list of active accounts from the account server 100, and at block 204 uses this list to update its local storage with the current list of active users. The routine enters an idle state at block 206, from which it exits in response to one of three events: Receipt of a further update from the account server 100, which triggers a return to block 202, or receipt of an access key 106 from a user, which invokes block 208 or 214 depending on whether the user presents the access key 106 at the parking facility's entry gate or exit gate. In block 208 an access key 106 is received from a user at an entry gate, which is then verified in block 210 by comparing the received access key 106 to the list of active users. If the access key 106 is associated with an active user, the routine branches to block 212, opens the entry gate, records the date and time of entry in its transaction log, and in block 222 transmits the user activity to the account server 100. If the access key 106 is not associated with an active user, the routine branches to block 224, issues a paper ticket, optionally informs the user of the rejected access key 106, and opens the entry gate. The routine then returns to the idle state of block 206.

In block 214 the routine receives an access key 106 from a user exiting the facility, and in block 216 tests whether a corresponding entry timestamp exists in a local transaction log. If so, the routine branches to block 218, opens the exit gate, and in block 222 transmits the transaction data to the account server 100. If the transaction log does not have a corresponding entry for the user entering the parking facility, the routine branches to block 220, applies the local parking facility rules for handling a lost paper ticket, and then executes blocks 218 and 222 before returning to the idle state. In some embodiments, block 222 calculates a balance due and requests the account server 100 to debit the user's account balance, and the account server 100 responds by debiting the user's account balance and transferring funds to the parking service provider 112.

In some embodiments, in block 210, the routine communicates with the account server 100 and requests an updated list of accounts instead of branching to block 224. In some embodiments, the parking service provider 112 receives updates regarding the status of individual accounts rather than an updated list of active accounts, and/or receives information about inactive accounts as well as active accounts, and/or maintains a list of users who are not authorized to enter. In some embodiments, in block 216, the routine re-verifies the account status rather than checking the local transaction log for an entry timestamp. In several embodiments, the routine defers execution of block 222 to only occur at specified intervals, rather than following each individual entry or exit.

Method for User Interaction with Parking System

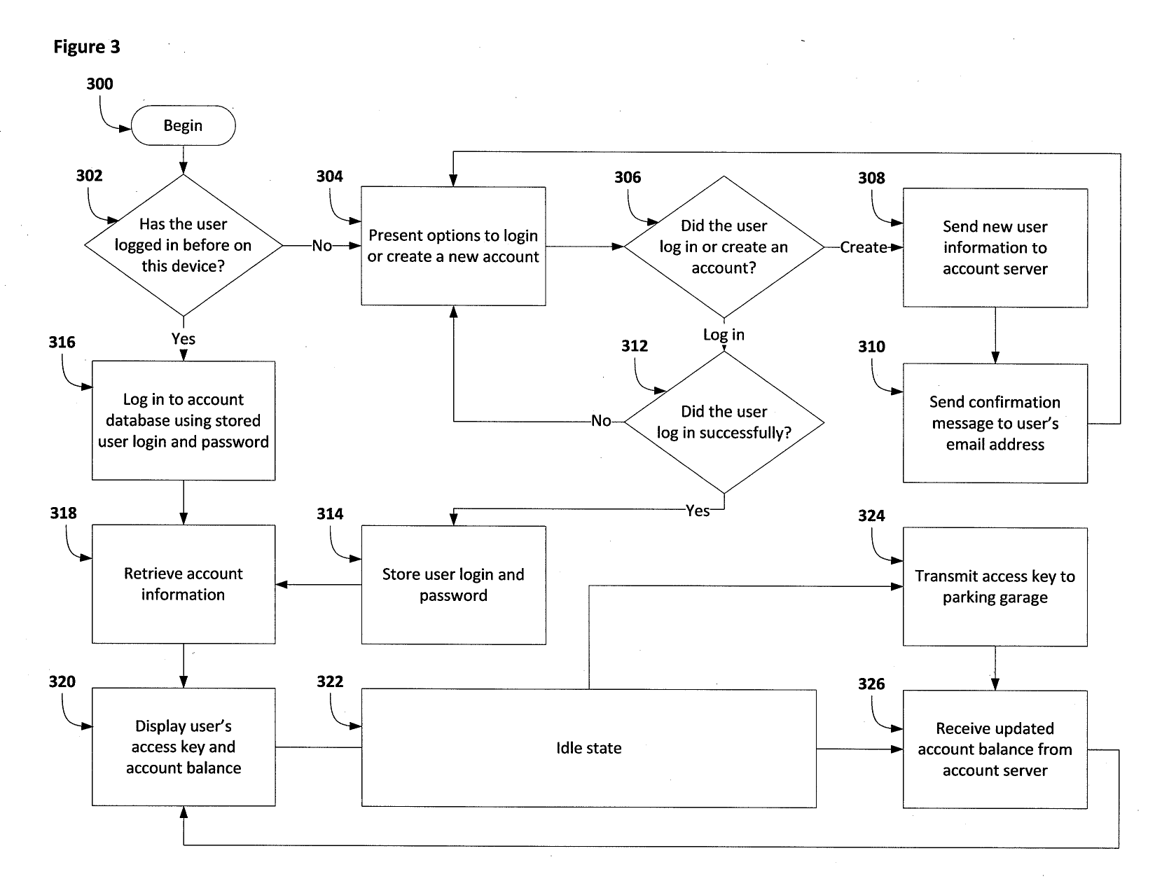

FIG. 3 illustrates one non-limiting embodiment by which a smartphone app or other user device allows a user of the parking system to create and log into a user account, obtain and present an access key 106, and monitor his or her account balance. In block 302 the app assesses whether the user has previously logged into a user account using this device, and if so branches to block 316 and uses the stored login and password to log the user into the system. If the app does not have a valid login and password for the user, the routine branches to block 304 and presents the user with option to create an account or to enter a valid login and password. In some embodiments, the routine does not store user logins and passwords and always invokes block 304 to present login and account creation options.

Block 306 receives user input with regard to creating or logging into an account. If the user creates a new account, the routine branches to block 308, sends the details of the account creation request to the account server 100, and in block 310 sends a confirmation email to the user's address. In some embodiments, block 310 is performed by the account server 100. If the user instead enters a login and password to an existing account, the routine branches to block 312 and verifies the user's credentials. If this verification is not successful, the routine returns to block 304 and re-presents the options to login or create an account. If the login and password are valid, the routine branches to block 314 and optionally stores the login and password to expedite future logins.

In block 318, the routine retrieves the user's account information from the account server 100. After retrieving the information, the routine proceeds to block 320 and displays the user's access key 106 and account balance. The routine then enters an idle state 322. Exit from the idle state may be triggered by, for example, transmitting the access key to a parking garage or other facility, as illustrated in block 324, which may cause the account server 100 to send an updated account balance, which is received in block 326. The routine may also enter block 326 from the idle state and receive an updated account balance in response to other events, such as the user transferring funds into the account. The routine then returns to block 320, displays the updated account balance, and returns to the idle state of block 326 to await further events.

### System for Processing Parking Account Transactions

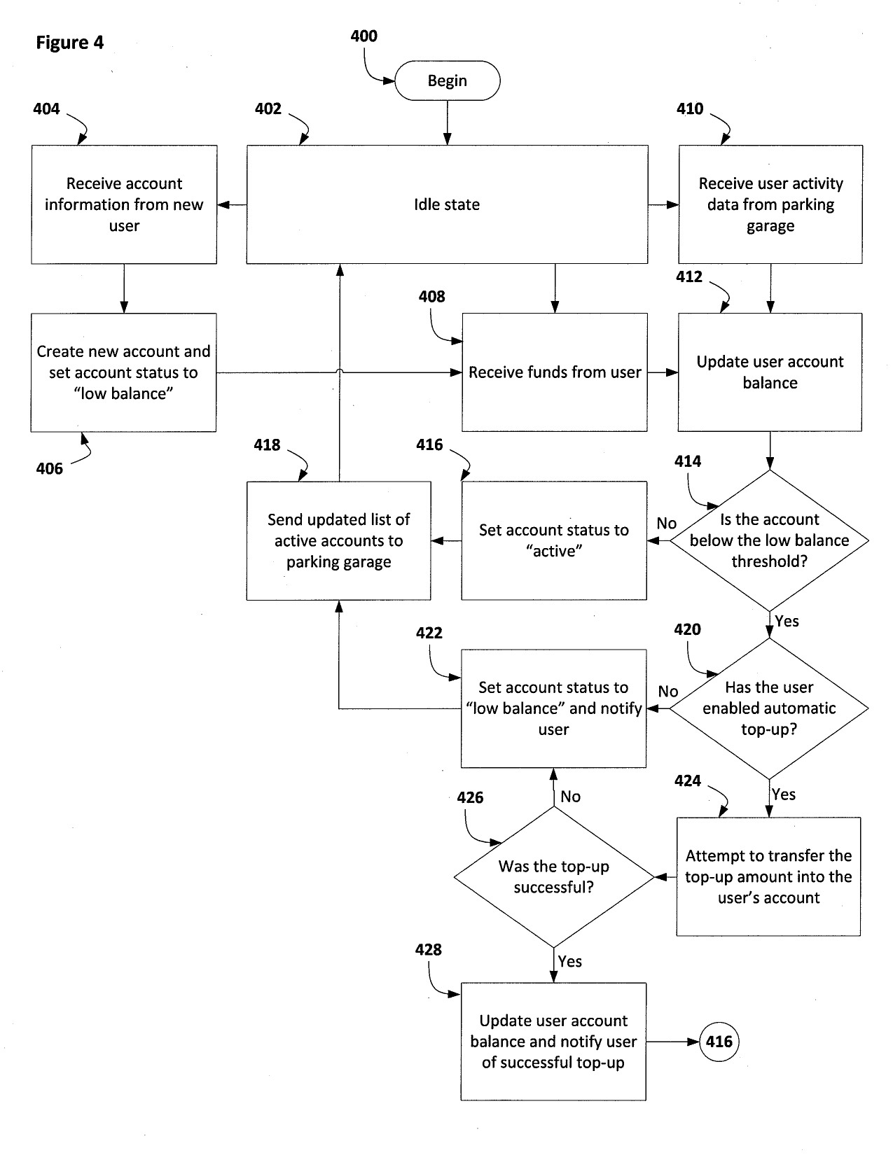

FIG. 4 illustrates a non-limiting example by which the account server 100 processes various account transactions, including creating an account, manually depositing funds, withdrawing funds through parking activity, and automatically depositing funds when the account balance falls below a minimum threshold. Block 402 represents the routine's idle state. Examples of transactions that cause the routine to exit the idle state include receipt of account information from a new user, which is processed in block 404. In some embodiments, new account information is received from a user device, as illustrated, for example, in FIG. 3. In additional embodiments, new account information is received from a web server, a dedicated kiosk, through an API, or other sources. In block 406, the routine creates a new account with an initial balance of zero, and optionally sets an account status of “low balance.” In some embodiments, the new account information contains a non-zero balance, in which case the account status is set in accordance with the balance. In some embodiments, a new user receives a credit as a promotion or incentive. In several embodiments, the balance is recorded in units of currency, such as dollars; in other embodiments, the balance is recorded in units of time such as minutes or hours.

Block 408 handles the receipt of funds from the user, which, in several embodiments, occurs as part of account creation, or may occur as a transaction associated with an existing account which triggers the routine to exit the idle state 402. Similarly, block 410 processes the receipt of user activity data from a parking garage or other facility. Examples of user activity data include, but are not limited to, parking transactions, transactions for related services such as car washes or valet parking, credits for participating in promotions and incentives, such as parking validations, and other events that affect the user's account balance. In block 412, the routine updates the user's account balance to reflect funds received or transactions processed. Block 414 tests whether, as a result, the user's account balance has fallen below a low balance threshold. Examples of a low balance threshold include a threshold set by the account server operator, a threshold set by the parking service provider, a threshold determined by an automated process, a threshold set by the user, and zero. In some embodiments, the system optionally warns the user when the account balance falls below a warning threshold, which, depending on the embodiment, may be related to the low balance threshold and/or may be user-specified.

If the account balance has not fallen below the low balance threshold, the routine branches to block 416, sets the account status to “active,” sends an updated list of active accounts to the parking garage in block 418, and then returns to the idle state 402. In some embodiments, the routine recognizes that the account is already in “active” status, and returns to the idle state without re-setting the account status or sending an updated list of active accounts. In some embodiments, the routine uses the account balance to determine whether an account should be on the list of active accounts, instead of maintaining a separate account status setting.

If the account balance has fallen below the low balance threshold, in embodiments with an automatic top-up option, the routine branches to block 420 and determines whether the user has enabled automatic top-up. In embodiments without an automatic top-up option, the routine branches to block 422. If automatic top-up is an option and the user has enabled it, the routine branches to block 424 and attempts to top up the account. In block 426 the routine determines whether the top-up was successful (for example, if funds were successfully obtained from the user); if so, in block 428 the user's account balance is updated to reflect the new balance, the user is optionally notified of the successful top-up, and the routine proceeds to block 416. If the top-up is not successful, the routine branches to block 422. In some embodiments, the user specifies whether to receive notice of a successful top-up attempt and/or whether to receive notice of a failed top-up attempt. In block 422, after a failed top-up attempt or if the top-up feature is not available or not enabled, the routine sets the account status to “low balance” and optionally notifies the user, then in block 418 sends an updated list of active accounts to the parking facility, and returns to the idle state in block 402. In various embodiments, the routine in block 418 sends an updated list of active accounts immediately following each change in account status, periodically for all account status changes within a given time period, or in response to a request from a parking facility. In some embodiments, the update includes only the subset of accounts whose status has changed. Although FIG. 4 refers to a single parking garage, one skilled in the art will understand that the routine is suitable for sending, receiving, and aggregating data from multiple parking facilities.

### System for Detecting Approaching Vehicles

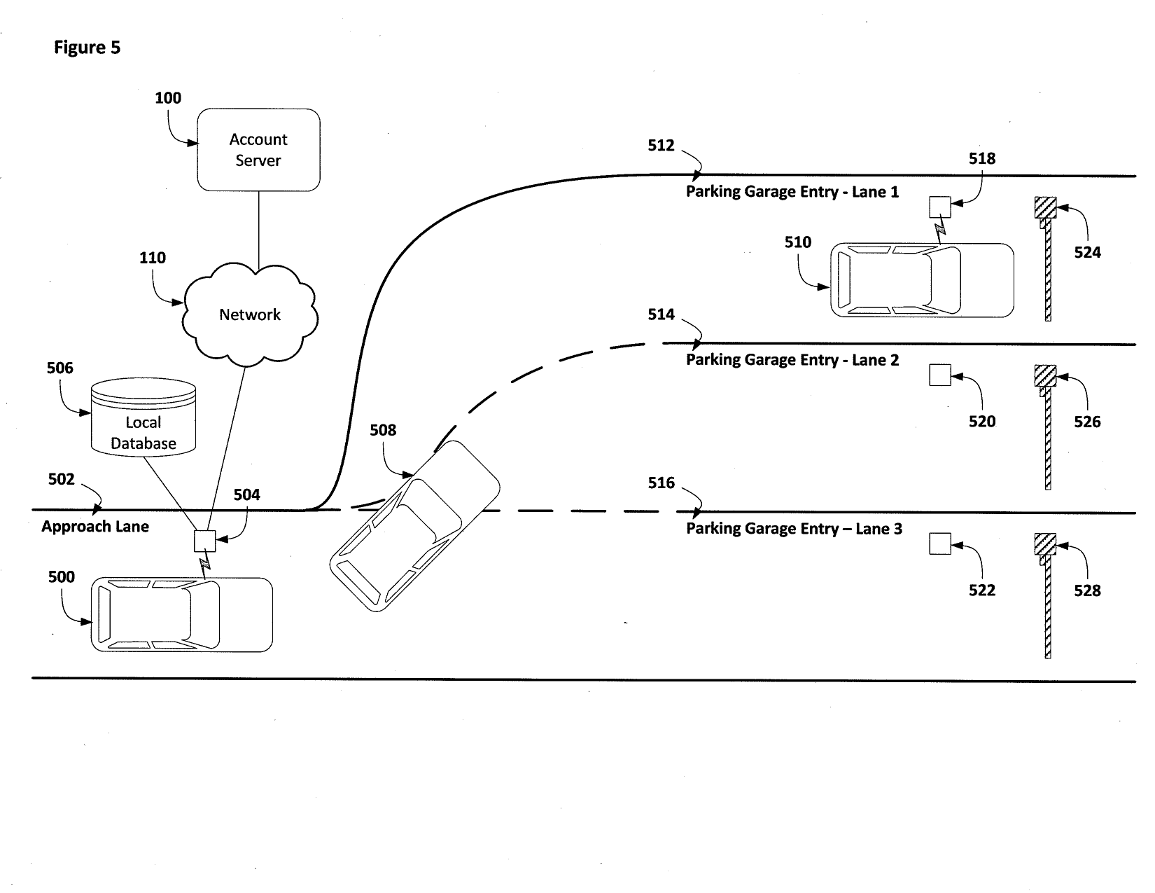

FIG. 5 illustrates a non-limiting embodiment of a system for detecting and pre-screening approaching vehicles to reduce the time required to enter (or exit) a parking facility. In an embodiment, an approaching vehicle 500 in an approach lane 502 transmits an access key 106 to an approaching vehicle detector 504. In various embodiments, the access key 106 is transmitted via cellular telephone frequencies, Wi-Fi, Bluetooth, RFID, audio signals or video signals. In some embodiments, the transmission of the access key 506 is accompanied by geolocation data, measurements of received signal strength, or other data that supports measuring the proximity of the vehicle 500 to the approaching vehicle detector 504.

The approaching vehicle detector 504 is equipped with the necessary receiver or receivers to detect transmission of the access key 106. In some embodiments, the approaching vehicle detector 504 is further equipped with cameras and/or microphones. Upon receiving the access key 106, the approaching vehicle detector 504 communicates with the parking facility's local database 506 to determine whether the access key 106 is associated with an active user account. If the local database 506 cannot provide this information, the approaching vehicle detector 504 queries the account server 100 via the network 110. In some embodiments, the approaching vehicle detector 504 initiates a query to the account server 100 regardless of whether the local database 506 contains information about the user account. In several embodiments, the approaching vehicle 500 is not required to stop or slow when approaching the approaching vehicle detector 504, and is not required to wait for a response from the local database 506 or the account server 100.

In some embodiments, the approaching vehicle detector 504 may initiate one or more promotions, notifications, and/or interactions with associated electronic and/or computing devices. For example, as the approaching vehicle detector 504 detects and/or reads an access key 106, a mobile computing device associated with the access key may receive a welcome message, a personalized message, promotional message, coupon, access to a wireless network, and/or some other notification (including, for example push notifications). A user may be prompted to opt-in and/or to join a wireless network upon passing a detector. In some embodiments, a mobile application and/or app on the mobile computing device may receive the message and/or push notification. An external screen and/or monitor in the parking facility may also display a welcome message, which may be personalized. In some embodiments, where the user presents a printed medium with an access key, an identified nearby mobile computing device may receive the message and/or push notification. It will be appreciated that the messages and/or notifications associated with an access key presented and/or detected at detector may be implemented at an entry, exit, access, and/or some other detection point.

As a detected vehicle 508 approaches the parking facility, it may enter the facility through one of a number of entrances. FIG. 5 illustrates three such entrances as entry lanes 512, 514, and 516, leading to entrance gates 524, 526, and 528 respectively. One skilled in the art will understand that the systems disclosed herein may also be applied to a facility with any number of entry lanes. In some embodiments, the approach lane 502 is also an entry lane. In some embodiments, the approach lane 502 is not dedicated to the parking facility and may contain vehicles, including vehicles that transmit access keys 106, which do not intend to enter the parking structure.

While a detected vehicle 508 approaches the parking facility, the results of the queries initiated by the approaching vehicle detector 504 regarding the access key 106 received from this vehicle 508 are provided to the entrance gate detectors 518, 520, and 522, which are associated with entrance gates 524, 526, and 528, respectively. These results indicate whether the detected access key 106 is associated with an active account. As entering vehicle 510 approaches a gate detector 518, it re-transmits the access key 106, which is now detected by the gate detector 518. If the query results indicate that the access key 106 is associated with an active user account, the gate detector 518 instructs the entry gate 524 to open automatically as the entering vehicle 510 approaches. The system thus reduces the time spent waiting for the entry gate 524 to open. In some embodiments, the gate detector 518 displays a personalized message to the entering vehicle 510, and if necessary informs that user that the transmitted access key 106 is expired, invalid, or that the user's account balance is too low. In several embodiments, if the entering vehicle 510 does not have a valid access key 106, the parking facility employs other methods of processing an entering vehicle, such as issuing a paper ticket. In some embodiments, the gate detectors 518, 520, and 522 independently query the local database 506 and the account server 100 if they do not receive results from queries initiated by the approaching vehicle detector 504. In some embodiments, the approaching vehicle detector 504 communicates to the gate detectors 518, 520, and 522 that queries are pending.

In some embodiments, there may be variations of the local and/or automated parking facility system to automatically open entrance/exit gates as vehicles approach. For example, as illustrated by FIG. 5, vehicle 500 and vehicle 508 may approach entrance gates 524, 526, and 528 in close proximity. In some embodiments, the local and/or automated parking facility system may be adapted and/or configured to open entrances and/or exit gates automatically and/or without a vehicle needing to stop. Additionally, there may be no need for the driver of the vehicle to present their mobile computing device and/or access key to the gate detector. For example, as vehicle 500 and vehicle 508 approach and/or pass gate vehicle detector 504 the parking facility may prepare entrance gates 524, 526, and 528 to open automatically. There may be an algorithm and/or module to determine the entrance/exit gate for a particular vehicle among a group of vehicles. For example, vehicle 500 and/or vehicle 508 may use entry lanes 512, 514, or 516, and, therefore, entrance gates 524, 526, or 528, respectively, may be prepared to open automatically. The gate detectors 518, 520, and 522 may be configured to determine the proximate location of vehicle 500 and/or vehicle 508 through Wi-Fi, GPS, wireless, radio frequency, Bluetooth, some other location data, or some combination thereof to automatically open and/or communicate with the local and/or automated parking facility system. For example, there may be a configurable threshold proximity, such as ten or fifteen meters, where the closest gate detector determines the corresponding vehicle that will be approaching. Therefore, the gate may be opened automatically for the appropriate vehicle and/or the appropriate account associated with the vehicle may be updated and/or processed. In some embodiments, a similar system may be used for automatic gate openings for exits of the parking facility.

In some embodiments, the local and/or automated parking facility system may use one or more technologies to determine vehicle location. In a non-limiting example, a mobile computing device such as a smartphone, tablet, or the like may wirelessly transmit a location to the local and/or automated parking facility system based on a MAC address through Wi-Fi. In some embodiments, a mobile computing device, wireless keycard, or the like may transmit a radio frequency identification code associated with an account wirelessly to the local and/or automated parking facility system. An application or app on the mobile computing device may wirelessly transmit a signal while in the parking facility. In some embodiments, one or more location technologies may be used in combination to determine the proximate location of the vehicle in or around the parking facility.

In some embodiments, as a user is proximate to or inside a parking facility with a wireless transmitter and/or mobile computing device, the local and/or automated parking facility system may begin pre-processing of an account to facilitate entering and/or exiting the parking facility. In a non-limiting example, a user has parked at a facility by wirelessly transmitting the user's account information with a keycard and/or mobile computing device. When the user, carrying the keycard and/or mobile computing device, returns to the parking facility, the automated parking facility system may begin pre-processing their account to allow for efficient exit processing of the user's account. Pre-processing may comprise caching and/or loading data and/or account information for the particular user, calculating the duration of the user's stay at the parking facility, and/or calculating any fees associated with the user and/or account. As a result, the user may exit the automated parking facility system with greater efficiency because data associated with the user and/or account has been previously loaded and/or calculated.

Although FIG. 5 is described in terms of vehicles 500, 508, and 510 entering a parking facility, alternative embodiments include vehicles exiting a parking facility via the same system. In some embodiments, the gate detector 518 displays a personalized message to an exiting vehicle. In an embodiment, the personalized message includes an account balance and informs the user whether he or she has sufficient balance to pay for parking services. In another embodiment, the personalized message prompts the user to initiate a top-up transaction and increase the account balance.

### System for Detecting Departing Drivers

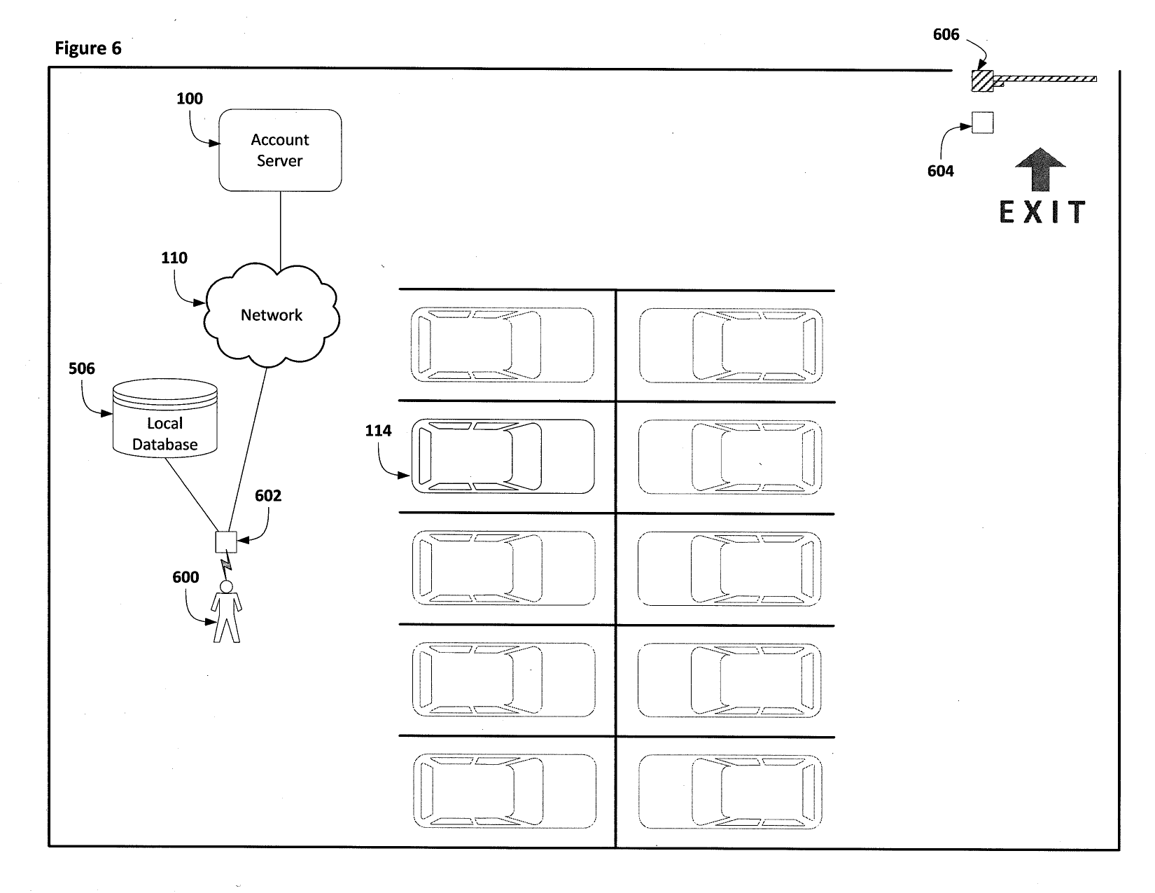

FIG. 6 illustrates one embodiment of a similar system for detecting and pre-screening drivers as they leave a parking facility. A driver 600 preparing to leave the facility transmits an access key 106 to a departing driver detector 602. The departing driver detector 602 performs a similar function to the approaching vehicle detector 504, and in various embodiments is similarly equipped to receive the access key 106. In some embodiments, the departing driver detector 602 is positioned near prior devices for payment and processing of paper tickets. Upon receiving the access key 106, and as the driver 600 proceeds to his/her vehicle 114, the departing driver detector 602 communicates with the local database 506 and the account server 100 via the network 110 as previously described to determine whether the access key 106 is associated with an active user account. The vehicle 114 then approaches an exit gate detector 604 with an associated exit gate 606. Although FIG. 6 illustrates a single exit gate, one skilled in the art will recognize that the system may be applied to any number of exit gates. The exit gate detector 604 performs a similar function to the entrance gate detectors 518, 520, and 522 depicted in FIG. 5, and as the vehicle 114 approaches receives the results of the queries initiated by the departing driver detector 602. In some embodiments, the exit gate detector 604 performs the functions of the departing driver detector 602.

When the exit gate detector 604 receives the transmitted access key 106 from the departing vehicle 114, the exit gate detector 604 confirms whether the transmitted access key 106 is associated with an active user account, and if so instructs the exit gate 606 to open automatically for the vehicle 114. In some embodiments, if the detected access key 106 is not associated with an active account, the exit gate detector 604 employs other methods for processing a paper ticket and/or for handling a lost ticket.

### Method for Detecting and Processing Access Keys

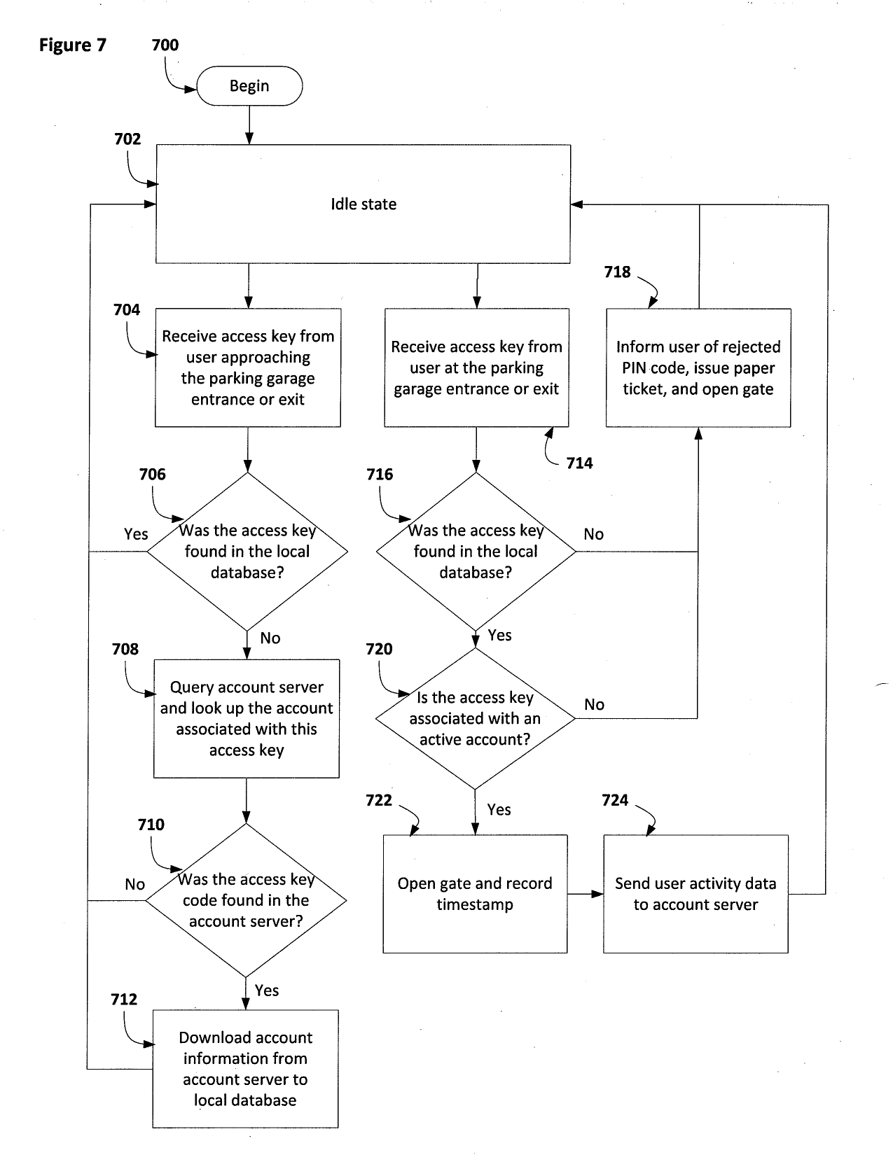

FIG. 7 illustrates a non-limiting embodiment of a routine implemented by a detector 504, 518, 520, 522, 602, and/or 604 in various embodiments. In block 702 the detector is in an idle state while awaiting detection of an access key 106. For a detector that performs a pre-screening function, such as an approaching vehicle detector 504, detection of the access key 106 occurs in block 704. In block 706, the routine determines whether the local database 506 can associate the access key 106 with a user account. If so, the routine returns to the idle state 702. If not, the routine branches to block 708 and queries the account server 110 for an account associated with the access key 106. In block 710, the routine determines whether the query result found an account associated with the access key; if the query was successful, the routine branches to block 712 and downloads account information from the account server 110 to the local database 506. The routine then returns to the idle state 702. In some embodiments, a successful query causes the routine in block 710 to branch to block 722 and perform a gate-opening function, instead of branching to block 712. In some embodiments, the routine transmits the results of the queries performed in blocks 706 and 708 to a second detector that performs a gate-opening function.

Block 714 illustrates a detector that performs a gate-opening function, such as an exit gate detector 604, receiving an access key 106 from an approaching driver 600 and/or vehicle 114. In block 716, the routine determines whether the access key 106 is found in the local database, and if so branches to block 720 and determines whether the access key 106 is associated with an active account. If the access key 106 is not found in the local database, or is not associated with an active account, the routine branches to block 108 and takes appropriate actions to handle a rejected access key 106. Examples of such actions include issuing a paper ticket, informing the driver 600 of a low balance, offering the driver 600 an opportunity to reactivate the account, or following local rules for handling of a lost ticket. In several embodiments, the routine queries the account server 110 if the access key 106 is not found in the local database 506, or if the information in the local database 506 has not been verified with the account server 110 within a specified period of time.

When the access key 106 is found in the local database and is associated with an active account, the routine branches to block 722, instructs the gate associated with the detector to open, and records the timestamp when the account holder entered or exited the parking facility. In block 724, the routine sends the timestamp and other user activity data to the account server 110, and then returns to the idle state in block 702. In some embodiments, the routine calculates the delta between the entry and exit times and sends the delta to the account server 110. In several embodiments, the timestamp and/or the delta is rounded to a unit of time, such as the nearest 15 minutes, the nearest half hour, or the nearest hour. In some embodiments, the routine only reports durations that exceed a specified interval, such as “two hours free parking,” and/or interact with external data sources to implement a “free parking with validation” interval.

In view of the disclosure presented herein, there is provided in several embodiments, a system for automating processing of parking transactions, comprising: an account server comprising and a communications network that connects the account server to a parking facility entrance control system. In several embodiments, the account server comprises a database that stores user account information for each of the one or more users of parking services. In several embodiments, the account service additionally comprises an automated parking transaction engine that creates, in the database, a user account for each of one or more users of parking services and associates an access key with each of the user accounts, the access key being stored in the database. In several embodiments, the account server also comprises a user interface that receives an account creation request, the user interface configured to transmit the request to the automated parking transaction engine to create said account and configured to transmit the access key to each of the one or more users of parking services and transmits the access key to each of the one or more users of parking services.

In several embodiments, the account server is connected to a parking facility entrance control system via the communications network, in order to allow ingress and egress from an entrance/exit of a parking facility. In several embodiments, the parking facility entrance control system comprises one or more parking entrance regulators for controlling access to one or more entrances of a parking facility. In several embodiments, the parking facility entrance control system an entrance detection sensor associated with each of the one or more entrances that detects the access keys of one or more users entering or exiting the parking facility.

In several embodiments, the parking facility entrance control system further comprises one or more exits equipped with parking exit regulators. In several embodiments, the facility entrance control system further comprises an exit detection sensor associated with each of the one or more exits that detects the access keys of the one or more users of parking services.

In several embodiments, the user account information includes, but is not limited to, personal identification information and an account balance. In several embodiments, the user account information also includes one or more of a user-set or pre-determined low balance threshold limit and user-set or pre-determined automatic top-up amount.

In several embodiments, the communications network is configured to communicate with a mobile device of a user that transmits the access key to the entrance detection sensor (or exit detection sensor.

In several embodiments, the mobile device receives from the account server and account balance of that specific user and displays the account balance on the mobile device of the user. In several embodiments, the user interface receives payment transactions.

In several embodiments, there is provided a method for detecting a vehicle approaching a parking facility, comprising detecting an access key transmitted by the vehicle and/or mobile computing device as it approaches a vehicle detector; associating the access key with a user and an account status; determining whether the account status allows entry to the parking facility; detecting the access key transmitted by the vehicle as it approaches an entrance gate; and opening the entrance gate for an access key associated with an account status that allows entry.

In several embodiments, the account status is determined by comparing the account balance to a threshold. In several embodiments, the threshold is zero. In several embodiments, the vehicle detector is positioned at a location sufficient to allow completion of the identifying and determining steps before detecting the access key at the entrance gate.

In several embodiments, the methods further comprise transmitting a message to the user when the account status does not allow entry to the parking facility. In some such embodiments, the method further comprises presenting payment options to the user when the account status does not allow entry to the parking facility. In one embodiment, the payment options include, but are not limited to, a top-up transaction. In several embodiments, the method further comprises transmitting a message to the user when the account balance falls below a threshold.

Additionally, in several embodiments, there is provided a method for detecting a user departing a parking facility, comprising detecting an access key transmitted by the user as he or she approaches a departing user detector; associating the access key with the user and an account balance; determining a balance due for provided parking services; comparing the account balance to the balance due; detecting the access key transmitted by the user as he or she approaches an exit gate in a vehicle; debiting the account balance by the balance due for a detected access key associated with an account that has sufficient balance to pay the balance due; and opening the exit gate for the detected access key associated with an account that has sufficient balance to pay the balance due.

In several embodiments, the method further comprises presenting payment options for a detected access key associated with an account that has insufficient balance to pay the balance due. In one embodiment, the payment options include, but are not limited to, a top-up transaction.

In several embodiments, the methods further comprise transmitting a message to the user when debiting the account balance causes the account balance to fall below a threshold. In such embodiments, the methods optionally further comprise initiating a top-up transaction when debiting the account balance causes the account balance to fall below a threshold.

### EXAMPLES

In several embodiments, the systems and methods disclosed herein comprise a website which will enable a user to create a parking services account at the level of his or her choosing. The user will select between predetermined amounts for parking time at a participating parking service provider's facility (for example, $25, $50, $75, $100, or other amounts). Additionally, the user will be able to set an automatic account reload amount (for example, $10, $25, $50, $100, or other amounts, or amounts to reach a certain pre-indicated account balance) whereby an automated payment will be made to the user's account utilizing their predetermined amount when their balance reaches the reload amount.

Once the user has enrolled and created an account, an email will be sent to the user welcoming them to the program and providing login information which can be used to access their account later (either via a website or via a mobile app) to retrieve their access key. The user will also be given the option to email or pre-print their access key if they do not have a mobile app. In each case, the access key can be presented for entry and exit to any participating parking facility.

When the user arrives at a participating parking facility, the user will be prompted for their access key (which can be provided by the mobile app, email, or in print). Any enabled parking entrance will accept the access key. If the user wishes to utilize valet parking services, the access key will be scanned upon arrival by a handheld scanner held by the valet in order to record the arrival time.

When exiting the parking facility or retrieving the car from valet parking attendants, the user will again scan the access key using a mobile app, email, or pre-printed access key to exit and the systems will calculate the cost for parking and complete the automated transaction. Optionally, parking scanners will be configured to give the user their account balance upon exiting.

If the user does not have sufficient funds to cover the cost of the present parking transaction, the parking scanners will notify the user to pay the balance with a credit card (or cash, if the parking facility is so equipped). In such cases, the user will be able to recharge their account at any time (even instantly at the exit site) by visiting the website through which they initially registered their account.

In a preferred embodiment, the user transmits his or her personalized access key as they approach the participating parking facility, which is equipped to receive and verify the access key before the user reaches an entrance gate. The parking facility verifies the access key against a local database, queries a remote account server if the local database does not have current information, and preferably completes these queries before the user reaches the gate. When the user arrives at the entrance gate, the user re-transmits the verified access key and the entrance gate opens automatically.

When a user who has parked in a participating parking facility enters the facility to return to his or her vehicle and depart, the user transmits his or her access key to the parking facility, which is equipped to receive and verify the access key before the user reaches an exit gate. The parking facility verifies the access key and account balance with the account server, and preferably completes these queries before the user reaches the exit gate. When the user arrives at the exit gate, the user re-transmits the verified access key, and the parking facility automatically opens the exit gate and debits the user's account.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although embodiments of the invention have been disclosed in the context of certain preferred embodiments and examples, it will be understood by those skilled in the art that the inventions disclosed herein extend beyond the specifically disclosed embodiments to other alternative embodiments and/or uses of the inventions and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the inventions disclosed herein disclosed should not be limited by the particular disclosed embodiments described above.

What is claimed is:

1. (canceled)

2. An automated parking facility system comprising:
a non-transitory data storage device configured to store data relating to one or more accounts for one or more users of a parking facility, the data comprising an access key associated with the one or more accounts;
an account manager engine configured to generate the one or more accounts and store the one or more accounts in the non-transitory data storage device, and wherein an automated gate system of the parking facility is configured to receive the access key associated with the one or more accounts as data input to open one or more access points of the automated gate system of the parking facility;
a communication engine configured to transmit account data comprising the access key to one or more user computing devices;
an interface engine configured to transmit account data comprising the access key to the automated gate system of the parking facility and to receive account activity data from the parking facility; and
one or more computing systems configured to operate the account manager engine, the communication engine, and the interface engine, wherein the one or more computing systems comprises one or more hardware processors and a non-transitory data storage medium.

3. The system of claim 2, wherein the access key comprises a barcode readable by the automated gate system of the parking facility from the one or more user computing devices.

4. The system of claim 2, wherein the access key is displayable from a mobile application of the one or more user computing devices.

5. The system of claim 2, wherein the access key comprises a printed medium from the one or more user computing devices and the printed medium is readable by the automated gate system of the parking facility.

6. The system of claim 2, wherein the access key is usable for additional services and activities.

7. The system of claim 2, wherein the automated gate system of the parking facility is further configured to receive the access key as data input through wireless transmission.

8. The system of claim 2, wherein the account manager engine is further configured to receive a request to generate one or more accounts for one or more users of the parking facility, and wherein the request to generate the one or more accounts comprises web data.

9. The system of claim 2, wherein the interface engine is further configured to add, modify, and delete local accounts of the parking facility.

10. An automated parking facility system comprising:
a non-transitory data storage device configured to store data relating to one or more accounts for one or more users of at least a first parking facility, the data comprising balance data associated with the one or more accounts;
an account manager engine configured to generate the one or more accounts, store the one or more accounts in the non-transitory data storage device, and debit and credit the balance data associated with the one or more accounts based at least in part on durational parking data for the one or more users of the first parking facility;
an interface engine configured to transmit account data associated with the one or more accounts to the first parking facility, and to receive the balance data associated with the one or more accounts from the first parking facility; and
one or more computing systems configured to operate the account manager engine and the interface engine, wherein the one or more computing systems comprises one or more hardware processors and a non-transitory data storage medium.

11. The system of claim 10, wherein the non-transitory data storage device is further configured to store data relating to one or more accounts for one or more users of at least the first parking facility and a second parking facility;
wherein the account manager engine is further configured to debit and credit the balance data associated with the one or more accounts based at least in part on durational parking data for one or more users of the first parking facility and the second parking facility; and
wherein the interface engine is further configured to transmit account data associated with the one or more accounts to the first parking facility and the second parking facility, and to receive balance data associated with the account from the first parking facility and the second parking facility.

12. The system of claim 10, wherein the one or more accounts is configurable to automatically update the balance data associated with the one or more accounts when the balance data is below a configurable balance level.

13. The system of claim 10, wherein an automated gate system of the first parking facility is configured to open access points of the first parking facility based at least in part on the balance data associated with one or more accounts.

14. The system of claim 10, wherein an automated gate system of the first parking facility is configured to receive alternative payment based at least in part on the balance data associated with one or more accounts.

15. The system of claim 10, wherein at least part of the balance data associated with one or more accounts is displayable from one or more computing devices.

16. The system of claim 10, wherein the balance data associated with one or more accounts is usable for additional services and activities.

17. The system of claim 10, wherein the balance associated with one or more accounts is updated from an external funding source.

18. Non-transitory computer storage comprising instructions for causing an automated parking facility system to implement:
an account manager engine configured to generate the one or more accounts for one or more users of a parking facility and store the one or more accounts in non-transitory computer storage, and wherein an automated gate system of the parking facility is configured to receive the access key associated with the one or more accounts as a data input to open one or more access points of the automated gate system of the parking facility;
a communication engine configured to transmit account data comprising the access key to one or more user computing devices; and
an interface engine configured to transmit account data comprising the access key to the automated gate system of the parking facility and to receive account activity data from the parking facility.

19. The non-transitory computer storage of claim 18, wherein the access key comprises a barcode readable by the automated gate system of the parking facility from the one or more user computing devices.

20. The non-transitory computer storage of claim 18, wherein the interface engine is further configured to add, modify, and delete local accounts of the parking facility.

21. The non-transitory computer storage of claim 18, wherein the account manager engine is further configured to store balance data associated with the one or more accounts in the non-transitory computer storage.
